(19) United States
(12) Patent Application Publication
(10) Pub. No.: US 2006/0191631 A1
(43) Pub. Date: Aug. 31, 2006

(54) Bonding apparatus

(75) Inventors: Eisaku Kojima, Uji-Shi (JP); Takehiko Wada, Ibaraki-shi (JP)

Correspondence Address: FOLEY AND LARDNER LLP;SUITE 500, 3000 K STREET NW, WASHINGTON, DC, 20007, US

(73) Assignee: OMRON CORPORATION

(21) Appl. No.: 11/350,270

(22) Filed: Feb. 9, 2006

(30) Foreign Application Priority Data
Feb. 10, 2005 (JP) 2005-034912

(51) Int. Cl. B32B 37/00; B29C 65/00

(52) U.S. Cl. 156/272.8; 156/379.6

(57) ABSTRACT

Laser generated from a laser generator is reflected by a laser mirror, passes through an array substrate (glass substrate) through a backup glass, and then, directly irradiated to an ACF in a pinpoint manner. The laser from the laser generator is set to have a wavelength whose transmittance of transmitting the TCP and the array substrate having the ACF inserted therebetween is higher than that of the other wavelength. The ACF is welded by this laser irradiation, so that the TCP and the array substrate are bonded to each other.

### BACKGROUND OF THE INVENTION

1. Field of the Invention

The present invention relates to a bonding apparatus suitable for bonding a liquid crystal display panel and a driver circuit substrate.

2. Description of the related art

Liquid crystal display devices are remarkably widespread as image display devices for personal computers and various other monitors.

In general, such a liquid crystal display device comprises an illuminating backlight that is a planar light source behind a liquid crystal display panel for irradiating the liquid crystal panel, that provides a certain spread, with even brightness as a whole. An image is thus formed on the liquid crystal panel.

Such a liquid crystal display device includes the aforementioned liquid crystal display panel which is typically composed of two glass substrates and a liquid crystal material sealed therebetween, a printed circuit substrate for driving the liquid crystal material on the liquid crystal display panel, the backlight unit disposed behind the liquid crystal display panel via a liquid crystal display panel holding frame, and an exterior frame for covering these components.

In a thin-film transistor (TFT) liquid crystal display device, one of the glass substrates constituting the liquid crystal display panel includes an array substrate, and the other glass substrate includes a color filter substrate.

On the array substrate are formed extraction electrodes for electrical connection to the above-mentioned printed circuit substrate and the like, in addition to TFTs as driver elements of the liquid crystal material, display electrodes, and signal lines. Since the TFTs are arranged regularly on the glass substrate, the glass substrate is referred to as an array substrate.

On the color filter substrate are formed common electrodes, black matrix, oriented film and the like in addition to color filters.

The printed circuit substrate is generally connected to (or mounted on) the extraction electrodes, formed on the array substrate, via a tape-automated bonding (TAB) tape carrier (hereinafter simply referred to as a “TAB”). Alternately, a package in which an LSI chip is connected to a tape film with the TAB technique (i.e., tape carrier package (hereinafter referred to as “TCP”)) is mounted. Further, COF (Chip on film/FPC) or SOF (System on Film) can be used as the similar package technique in addition to the TAB technique.

Input lead conductors of the TAB are connected to corresponding conductors of the printed circuit substrate. Meanwhile, output lead conductors of the TAB are connected to corresponding extraction electrodes of the array substrate. Soldering, an anisotropic conductive film (ACF) or an anisotropic conductive paste (ACP) has been conventionally used to connect the input lead conductors of the TAB to the corresponding conductors of the printed circuit substrate. Alternately, a technique or material such as NCP (Non Conductive Particle/Paste) is used. Similarly, the ACF, ACP or NCP is used to connect the output lead conductors of the TAB to the corresponding extraction electrodes of the array substrate. Further, the ACF, ACP or NCP is also used not only for these connections but also to connect the LSI chip on the TCP to the film.

Besides a mounting using TAB, another mounting technique called chip on glass (COG) may be used. COG is a technique to bond an IC silicon chip (hereinafter referred to as a “silicon chip”) onto the array substrate with the ACF, ACP or NCP. The ACF, ACP or NCP is simply referred to as ACF collectively hereinafter.

The ACF comprises a resin material as an adhesive with particles composed of a conductive material dispersed therein. There are two types of ACF, namely, thermoplastic ACF that uses thermoplastic resin as an adhesive and thermosetting ACF that uses thermosetting resin as an adhesive. Thermocompression involving heating and pressurizing is commonly used in both thermoplastic ACF and thermosetting ACF bonding techniques. A popular method to perform the thermocompression is to use a heater tool.

The conventional technique is such that, for example, the ACF having adhesiveness is stuck on the liquid crystal display substrate, and then, the lead portions of the TCP are overlapped thereon, whereby a heater head that is used for bonding and provided with a heater is used to the overlapped bonding section for applying pressure and heat, thereby carrying out thermocompression. The ACF is heated and cured due to the thermal conduction with the use of the heater, whereby the anisotropic conductive film is melted to weld the bonding section. Such technique has conventionally been used.

Such bonding methods incur various problems, since they do not consider a thermal expansion or contraction of the material. Particularly when applied to a large-sized liquid crystal display panel requiring a narrow pitch and a narrow frame, such bonding methods incur various problems, since thermal expansion and contraction are increased.

One such problem is an occurrence of uneven mounting caused by a difference in contraction between the array substrate abutting on the ACF, that is the adhesive, and a TAB or silicon chip after thermal expansion which occurs when assembling such TABs made of polyimide and the like and mounted components composed of silicon chips and the like.

The stronger the bonding force of the ACF is, the more the uneven mounting occurs. Such occurrence of unevenness becomes particularly evident upon mounting a silicon chip because of its high rigidity compared to that of the typically flexible TAB. This is a major factor affecting mounting of silicon chips for use with large-sized, high-resolution liquid crystal display panels.

In the case of mounting the TAB, the occurrence of uneven mounting is not as significant because polyimide has sufficiently low rigidity compared to that of glass. However, it includes the mechanism on the uneven mounting same as that upon mounting the silicon chip. If the temperature necessary for curing an ACF is 200 degrees Celsius, for example, then a heating temperature of the heater should be set at about 230 to 250 degrees Celsius. In this example, a temperature of a bottom surface of the array substrate reaches about 50 to 100 degrees Celsius. That is, a substantial temperature gradient arises in a direction from the silicon chip to the array substrate.

On the other hand, a substance contracts when a temperature falls, wherein the amount of contraction becomes great as the temperature difference before or after the temperature change is great. The amount of contraction of a silicon chip increases, since the heating temperature of the array substrate is lower than the heating temperature of the silicon chip. Accordingly, the silicon chip and the array substrate are all warped, since the amount of contraction on the ACF and the amount of contraction on the silicon chip are different from each other.

As an array substrate becomes thinner in response to a demand for thinner liquid crystal display devices in the future, or in the event that low-rigidity glass is used for an array substrate, such warping may pose a major mounting problem.

A color filter and the like may be damaged by heat from the heater tool, that is caused by a narrow frame which brings the heater tool coming too close to the components of the liquid crystal display panel. One example of a temperature required for curing an ACF ranges from approximately 170 degrees Celsius to 230 degrees Celsius; however, the heating temperature of the heater tool is set higher that the aforesaid range by 30 to 40 degrees Celsius.

Accordingly, substantial heat may be applied to the liquid crystal material, seal adhesive, color filter pigments, polarizers and the like of the liquid crystal display panel. Such heat, as understood, presents a risk of deforming the liquid crystal material and the seal adhesive.

In view of this, in the conventional bonding method, a TAB or silicon chip is heated by a thermal conduction, and an ACF is also heated by the thermal conduction from the TAB or silicon chip. It is considered that the array substrate is heated by a thermal conduction in case where the ACF is heated by using a thermal conduction. However, a glass constituting the array substrate has a smaller thermal conduction compared to the TAB or silicon chip. Therefore, the ACF can efficiently be heated by heating the TAB or silicon chip, instead of heating the glass substrate.

However, heating the TAB or silicon chip promotes the aforesaid temperature gradient.

Accordingly, in case where the array substrate (glass substrate) is heated by a thermal conduction with the use of the heater tool, it is difficult to realize to efficiently heat the ACF due to its small thermal conduction.

The Japanese Unexamined Patent Application No. 2002-249751 discloses a technique in which heating is performed by a conductive heat with the use of a heater tool, and a near-infrared lamp is irradiated. Specifically, near-infrared rays are irradiated on the whole of the array substrate, ACF, and TAB or silicon chip by the near-infrared lamp, whereby the irradiated rays are partly absorbed by the array substrate and TAB or silicon chip and are irradiated to a thermosetting resin.

The thermosetting resin irradiated by the near-infrared lamp produces radiant heat due to self-heating. Further, the above-mentioned application discloses a configuration wherein the thermosetting resin heats the ACF by the conductive heat from the array substrate by the heater tool or by the heat generated by the absorption. Describing more precisely, the whole of the array substrate, ACF, and TAB or silicon chip is set to have generally the uniform temperature by using the near-infrared lamp, thereby enabling a temperature control during a cooling process described later.

The aforesaid application also discloses a technique in which the temperature control of the array substrate and the silicon chip is carried out as the cooling process, whereby the difference in the temperature gradient is restrained to control the amount of contraction.

This configuration reduces the temperature difference between the silicon chip and the array substrate, thereby being capable of reducing the occurrence of warping.

As described above, the aforesaid application discloses a technique in which the ACF is irradiated by the near-infrared lamp and further, the ACF is heated by self-irradiating radiant heat and by conductive heat of the glass substrate by using the heater tool, in order to apply heat to the ACF for curing the same. Specifically, it discloses a heating method of the ACF by using the heater tool and the near-infrared lamp.

However, the ACF is basically welded by a thermal conduction, so that the ACF is required to be kept heated for a predetermined time. This causes a problem of time-consuming bonding. As it takes much time for bonding, heat is likely to conduct to the other components, which may be a cause of breakdown.

It also discloses the cooling process for reducing the temperature gradient. However, complicated control should be required to control the cooling process; thus, it is extremely difficult to control the cooling process.

### SUMMARY OF THE INVENTION

The present invention is accomplished to solve the foregoing problems, and aims to provide a bonding apparatus that can shorten a bonding time and can realize a mounting with high speed and high precision by irradiating laser beam to an ACF.

A bonding method according to the present invention is a method for physically and electrically bonding an extraction electrode composed of plural electrodes arranged on a glass substrate of a flat panel display and a connection electrode composed of plural electrodes arranged on a member, that has a thermal expansion coefficient and/or thermal contraction coefficient which are different from those of the substrate, so as to correspond to the extraction electrode, comprising: a step A in which the extraction electrode on the glass substrate and the connection electrode on the member are made opposite to each other to position the respective electrodes, and an anisotropic conductive material having conductive particles dispersed in an adhesive made of heat-reactive resin is sandwiched between the glass substrate and the member by the application of pressure; a step B in which laser beam is irradiated from a laser source, the laser beam passing through the substrate and/or the member to be absorbed by the anisotropic conductive material for heating the adhesive; and a step C for releasing the pressure after the cure of the adhesive which occurs during the laser irradiation or after the laser irradiation.

Preferably, the pressure in the step A is applied by clamping the glass substrate, the anisotropic conductive material and the member between a pressure head and a support base, wherein the laser beam in the step B passes through the pressure head or the support base to be absorbed by the anisotropic conductive material.

Preferably, the extraction electrode and the connection electrode are photographed through the pressure head and/or the support base with the state before the application of pressure in which the extraction electrode and the connection electrode are positioned, and light absorbed by the glass substrate and/or light absorbed by the member are irradiated in accordance with the positional deviation amount of the photographed extraction electrode and the connection electrode, thereby correcting the positional deviation of the extraction electrode and the connection electrode.

Preferably, the light absorbed by the glass substrate and/or the light absorbed by the member are irradiated between plural arranged electrodes.

Another aspect of the present invention is a bonding method for physically and electrically bonding an extraction electrode composed of plural electrodes arranged on a glass substrate of a flat panel display and a connection electrode composed of plural electrodes arranged on a member, that has a thermal expansion coefficient and/or thermal contraction coefficient which are different from those of the substrate, so as to correspond to the extraction electrode, comprising: a step D in which the extraction electrode on the glass substrate and the connection electrode on the member are made opposite to each other to position the respective electrodes, and an adhesive made of heat-reactive resin is sandwiched between the glass substrate and the member by the application of pressure; a step E in which laser beam is irradiated from a laser source, the laser beam passing through the substrate and/or the member to be absorbed by the adhesive for heating the same; and a step C for releasing the pressure after the cure of the adhesive which occurs during the laser irradiation or after the laser irradiation.

A bonding apparatus according to the present invention is for physically and electrically bonding, as a bonded member, an extraction electrode composed of plural electrodes arranged on a glass substrate, and a connection electrode composed of plural electrodes arranged on a member, that has a thermal expansion coefficient and/or thermal contraction coefficient which are different from those of the substrate, so as to correspond to the extraction electrode, with an adhesive made of heat-reactive resin or an anisotropic conductive material having conductive particles dispersed in the adhesive inserted therebetween, comprising: a first laser beam source for irradiating first laser beam having a predetermined wavelength to the adhesive made of the heat-reactive resin or the anisotropic conductive material for bonding the extraction electrode and the connection electrode by the heat generated from the adhesive; and a support base that has a transmission area for transmitting the first laser generated from the first laser beam source and supports the bonded member; wherein the first laser beam irradiated from the first laser beam source has high transmittance through the glass substrate and the member, and is set to have a wavelength with high absorptivity to the adhesive.

The bonding apparatus preferably further comprises a detecting unit for detecting the first laser beam transmitting the bonded member.

Particularly, the bonding apparatus further comprises a pressure unit for applying pressure to the bonded member with the support base, wherein the pressure unit is made of a material having high transmittance of the first laser beam, and the detecting unit detects the first laser beam transmitting through the pressure unit.

Particularly, the pressure unit has an adsorption hole for applying pressure to the bonded member as vacuum-adsorbing the bonded member.

Particularly, the reaction rate of the adhesive is measured based upon the light-receiving intensity of the laser beam detected by the detecting unit.

Particularly, the bonding apparatus further comprises a control unit that measures the reaction rate of the adhesive and controls the irradiation from the first laser beam source based upon the result of the measurement.

Preferably, the bonding apparatus further comprises a second laser beam source for irradiating second laser beam that is easy to be absorbed by the glass substrate or the member, wherein the second laser beam is irradiated so as to adjust the corresponding other electrode to one of the extraction electrode or the connection electrode.

Particularly, the second laser beam is irradiated between adjacent electrodes of the arranged plural electrodes to adjust the bonding position of the extraction electrode and the connection electrode.

Particularly, the bonding apparatus further comprises a pressure unit for applying pressure to the bonded member with the support base, wherein the pressure unit is made of a material having high transmittance of the first laser beam and the second laser beam.

Preferably, the first laser beam is at least one of semiconductor laser, solid-state laser or fiber laser.

According to the bonding method and bonding apparatus of the present invention, heat is applied to the adhesive made of the heat-reactive resin without giving an influence by the thermal conduction to the other circuit components, and the bonding is made possible. Therefore, warping or non-uniformity produced on the glass substrate or the member bonded to the glass substrate caused by the thermal conduction can be reduced, which makes it possible to execute a high-speed and high-precise bonding.

### BRIEF DESCRIPTION OF THE DRAWINGS

FIG. 1 shows a schematic block diagram for explaining a liquid crystal display device according to an embodiment 1 of the present invention;

FIG. 2 shows a conceptual view for explaining a TCP according to the embodiment 1 of the present invention;

FIGS. 3A, 3B and 3C show views for explaining an ACF;

FIG. 4 shows a conceptual view for explaining a bonding apparatus 100 according to the embodiment of the present invention;

FIG. 5 shows a schematic block diagram for explaining a laser irradiating section 15 according to the embodiment 1 of the present invention;

FIG. 6 shows a view for explaining a bonding of an array substrate (glass substrate) and a TCP by a bonding apparatus according to the embodiment 1 of the present invention;

FIG. 7 shows a graph for explaining a time taken for the reaction of the ACF by a laser irradiation according to the embodiment of the present invention;

FIG. 8 shows a graph for explaining a relationship between a laser wavelength and transmittance of an ACF in a laser irradiation according to the embodiment of the present invention;

FIG. 9 shows a table for explaining a mounting time in case where a TCP is bonded by a bonding apparatus according to the embodiment 1 of the present invention; and

FIG. 10 shows a view for explaining an alignment correction according to an embodiment 2 of the present invention.

### DETAILED DESCRIPTION OF THE PREFERRED EMBODIMENTS

The embodiment of the present invention will be explained hereinafter with reference to the drawings. Note that the same numerals are denoted to the same or corresponding components in the figures, and the explanation is not repeated.

### Embodiment 1

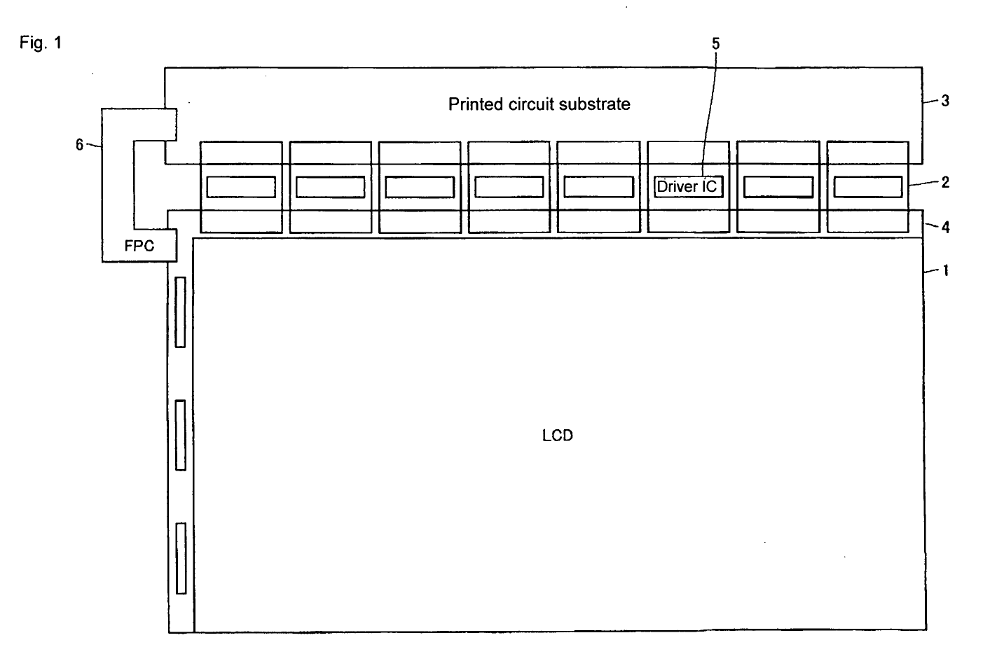

FIG. 1 shows a conceptual block diagram for explaining a liquid crystal display device according to the embodiment 1 of the present invention.

With reference to FIG. 1, a liquid crystal display device according to the embodiment 1 of the present invention has a liquid crystal display panel (hereinafter referred to as LCD) 1, an interface section 4 provided with wiring for connecting the LCD 1 and peripheral circuits arranged around the LCD 1, a printed circuit substrate 3 for driving a liquid crystal material mounted on the LCD, a TCP 2 disposed between the printed circuit substrate 3 and the liquid crystal display panel LCD 1 and including driver IC 5 for driving the components of the liquid crystal display panel, and a flexible substrate (hereinafter referred to as FPC) 6 for electrically connecting the printed circuit substrate 3 and the interface section 4.

A bonding apparatus according to the embodiment of the present invention will be explained mainly with reference to a bonding method of the TCP including the driver IC 5 used for connecting the liquid crystal display panel LCD and the printed circuit substrate 3.

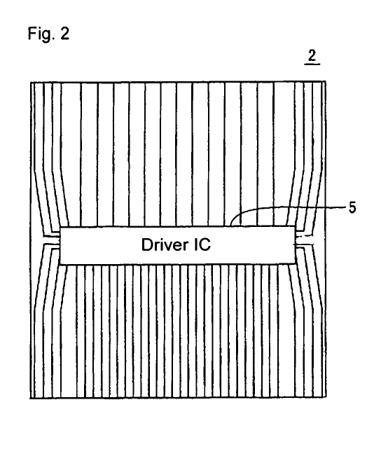

FIG. 2 shows a conceptual view for explaining the TCP according to the embodiment 1 of the present invention.

With reference to FIG. 2, the TCP according to the embodiment of the present invention includes driver IC 5, wherein plural input and output lead conductors from the driver IC 5 are provided.

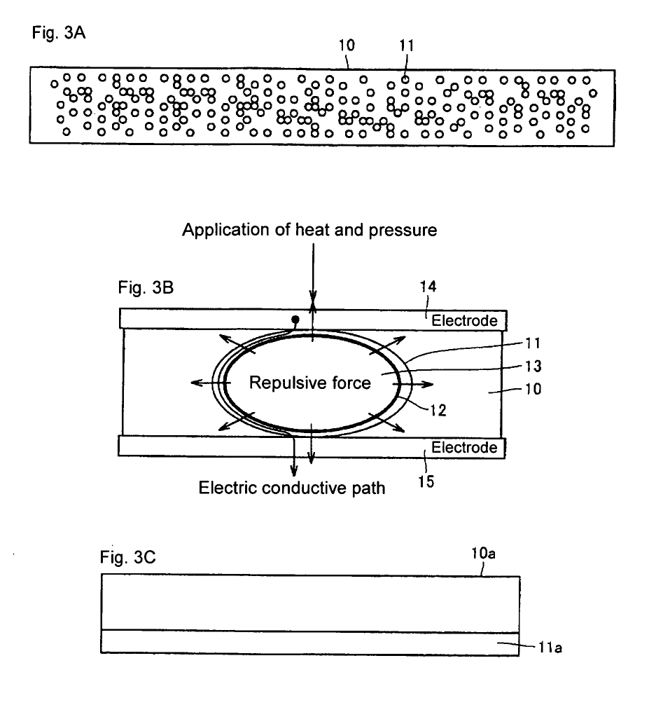

FIGS. 3A, 3B and 3C show views for explaining an ACF.

FIG. 3A is a view for explaining a structure of the ACF.

With reference to FIG. 3A, the ACF is composed of innumerable microparticles (conductive particles) 11 contained in a binder 10 that is an epoxy-based or acryl-based adhesive.

FIG. 3B shows a view for explaining the formation of the conductive path when heat and pressure are applied to the ACF.

With reference to FIG. 3B, when heat and pressure are applied to the ACF, i.e., heat and pressure are applied to the microparticle 11, repulsive force is generated on the resinous core 13 coated by nickel (Ni) plating 12 in the microparticle 11. The innumerable microparticles are consequently bonded to one another, thereby forming a conductive path between, for example, an upper electrode 14 and a lower electrode 15 through a gold plating 11 coated on the outer side of the nickel plating 12. Thus, the conductive path can be formed at the bonding section during the bonding.

FIG. 3C is a view for explaining a two-layer ACF.

This figure shows a two-layer ACF. In this ACF, a binder and microparticles are separated from each other, i.e., a binder area 10a and microparticle area 11a are separately formed. In this structure, the conductive path can also be formed by the manner same as the above-mentioned case. It should be noted that the use of the two-layer ACF can reduce the deviation upon the application of heat and application of pressure.

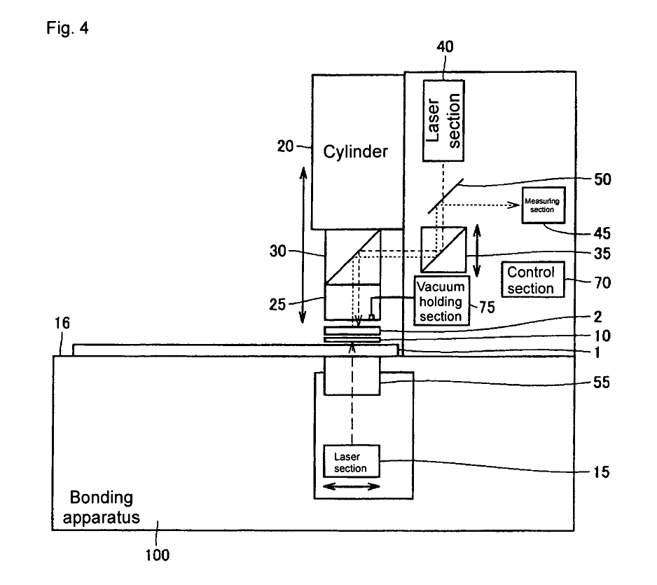

FIG. 4 shows a conceptual view for explaining a bonding apparatus 100 according to the embodiment of the present invention.

With reference to FIG. 4, the bonding apparatus 100 has a laser section 15 that irradiates laser beam, which is monochromatic light, to the ACF 10; a support base 16 for supporting the array substrate (glass substrate) 1 that is an LCD; a pressure head 25 made of glass; a pressure head 30 (prism type for branching light beam) made of glass; a cylinder 20; a laser section 40; a dichroic mirror 50; a total reflection mirror 35; a measuring section 45; a backup glass 55; a control section 70 for controlling the whole bonding apparatus 100; and a vacuum holding section 75. The TCP 2 and ACF 10 are inserted between the cylinder 20 and the array substrate 1.

The laser section 15 irradiates laser beam having a predetermined wavelength to the ACF 10. Specifically, the selected wavelength has relatively higher transmittance to the glass and higher absorptivity to the ACF compared to the other wavelengths.

The cylinder 20 applies pressure during the bonding of the TCP 2 and the array substrate 1 through the pressure heads 25 and 30 made of glass.

The pressure heads 25 and 30 made of glass are both made of glass. They transmit laser beam irradiated from the laser section 15. The pressure head 30 made of glass branches the laser beam and outputs the branched laser beam to the total reflection mirror 35. A product having high flatness, such as optical flat or optical window, can be used as the pressure head made of glass.

The total reflection mirror 35 reflects the laser beam irradiated from the pressure head 30 (prism type for branching light beam) made of glass. The dichroic mirror 50 further reflects the laser beam that is reflected by the total reflection mirror 35 and inputs the reflected laser beam to the measuring section 45.

The measuring section 45 receives the laser beam incident from the dichroic mirror 35 to measure the light-receiving intensity.

The vacuum holding section 75 vacuum-chucks the subject, that is the TCP 2 in this embodiment, from a suction hole provided at the pressure head made of glass, based upon the instruction from the control section 70. This prevents the alignment deviation, which may be caused by the application of pressure upon bonding the ACF and the TCP. Therefore, high-precise alignment can be performed.

It should be noted that the figure in this embodiment represents that the laser section 40 irradiates laser beam for performing an alignment correction described later, and the laser beam passing through the dichroic mirror 50 is irradiated to the TCP 2 through the total reflection mirror 35 and the pressure heads 25 and 30 made of glass. This will be explained later.

Although FIG. 4 shows that, as one example, one suction hole and the vacuum holding section 75 are coupled to each other via the pressure head made of glass, the present invention is not limited thereto. The vacuum-chuck can of course be performed by using plural suction holes.

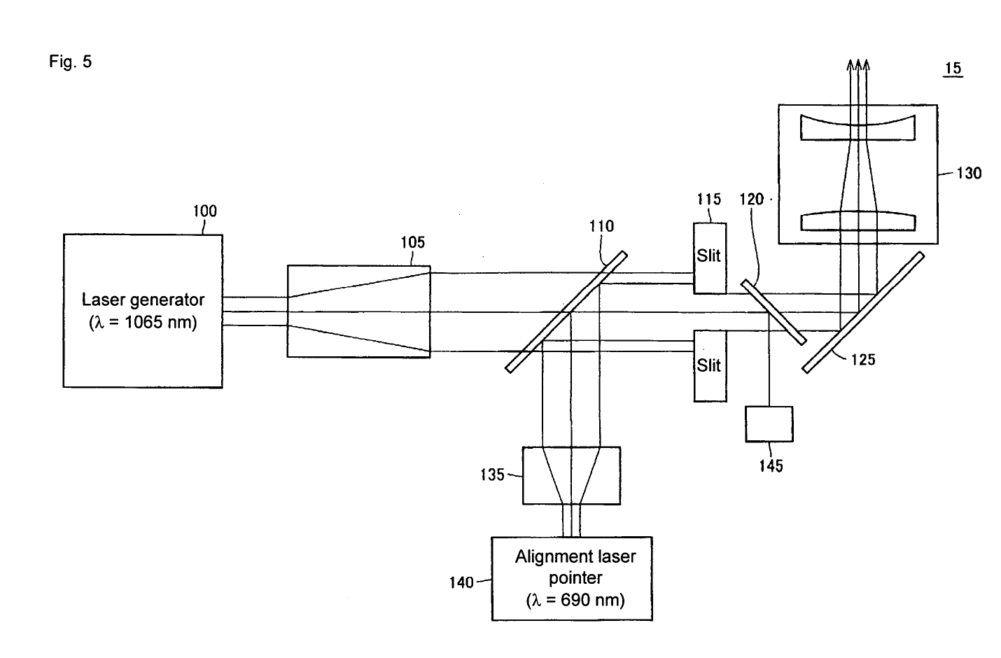

FIG. 5 shows a schematic block diagram for explaining the laser irradiating section 15 according to the embodiment 1 of the present invention.

With reference to FIG. 5, the laser irradiating section 15 according to the embodiment 1 of the present invention has a laser generator 200; a beam expander 105; a dichroic mirror 110; a slit 115; a beam sampler 120; a laser mirror 125; a beam expander 130; a laser line generator 135; an alignment laser pointer 140; and a power meter 145.

The laser generator 200 can use solid-state laser that emits laser having wavelength near λ=1064, such as YAG laser or the like, for example. The laser beam emitted from the laser generator 200 is polarized to parallel beam having predetermined width by the beam expander 105. After passing through the dichroic mirror 110, the parallel beam is made into slit-like beam by the slit 115. After passing through the slit 115, a part of the beam is reflected by the sampler 120 to be incident on the power meter 145. The power meter 145 detects the light-receiving intensity of the incident beam for determining whether laser having desired light intensity is emitted from the laser generator 200 or not. It adjusts the output from the laser generator 200 through the unillustrated control section 70 that controls the laser generator 200 and other components. The laser beam passing though the slit 115 is reflected by the laser mirror 125 to be incident on the beam expander 130. The beam expander 130 converges the incident laser beam and irradiates the same to the ACF 10.

The alignment laser pointer 140 is a laser generator for generating laser beam for the alignment adjustment. For example, it selects wavelength of visible light. In this embodiment, laser beam of 690 nm is used, for example. The laser beam emitted from the alignment laser pointer 140 is shaped by the laser line generator 135 and irradiated to the ACF 10 through the dichroic mirror 110 like the laser beam emitted from the laser generator 200. This laser beam is for the alignment adjustment, i.e., for positioning. The positioning control is performed by using this laser beam. Note that the laser mirror 125 is used as a reflecting element of laser beam at the laser irradiating section 15, but the present invention is not limited thereto. For example, a galvanomirror or polygon mirror, which is capable of carrying out a fine adjustment of an angle of reflection of laser, can of course be used instead of the laser mirror 125.

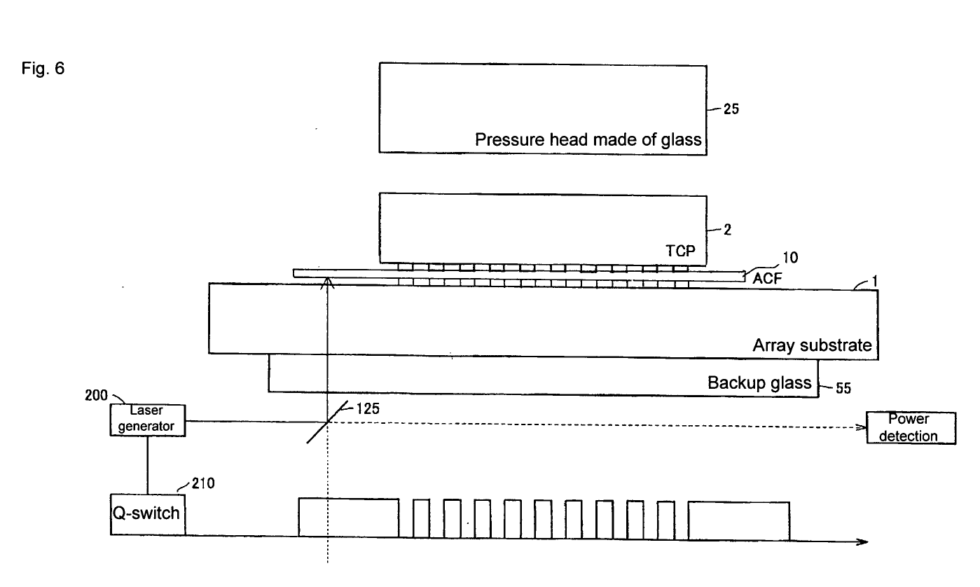

FIG. 6 shows a view for explaining a bonding process of the array substrate (glass substrate) and the TCP by using the bonding apparatus according to the embodiment 1 of the present invention.

As shown in FIG. 6, the respective electrodes of the array substrate (glass substrate) and the TCP are positioned, and then, laser beam emitted from the laser generator 200 is reflected by the laser mirror 125 and passes through the array substrate (glass substrate) 1 via the backup glass 55, thereby directly being irradiated to the ACF 10 in a pinpoint manner. Although not shown, the array substrate and the TCP are simultaneously captured by a camera via the backup glass 55 and the array substrate 1 from the side of the backup glass 55, which leads to an easy positioning. However, the present invention is not limited thereto. The positioning is possible by a capture from the upper side of the TCP with the use of a reference mark or the like. The laser irradiating section 15 is a so-called laser marker, which can irradiate laser beam to a predetermined place positioned on the support base 16 that is a sample placing table as drawing an optional locus.

In general, an ordinary laser marker can irradiate laser beam to a predetermined position by using CAD data. Therefore, the positioning control for the irradiated position can be executed by using CAD data of the liquid crystal display panel LCD, for example. The laser beam desirably draws an irradiation locus so as to locally concentrate energy in order to sufficiently heat a thin film. Note that the bonding strength can suitably be adjusted by appropriately controlling the amount of irradiating laser beam and/or irradiation locus of the laser beam. For example, a so-called wobbling method or filling method can be adopted. In the wobbling method, the irradiation is performed such that the irradiation locus turns around the center of the irradiation spot. On the other hand, in the filling method, the area to be irradiated is filled with a great number of parallel beams. These techniques are popular, so that the detailed explanation thereof is omitted in this specification.

The use of a so-called Q-switch 210 in the laser generator 200 enables the generation of pulse beam having extremely high Q-value. Specifically, laser of high energy density is irradiated, whereby bonding (mounting) in a short period becomes possible. Although this embodiment describes the case wherein the laser irradiation using pulse beam is executed as one example, the present invention is not limited thereto. For example, it is of course possible to irradiate continuous wave beam (CW beam) in which beam having predetermined energy amount is kept on being irradiated in a continuous manner.

FIG. 6 also represents the case in which a power detection of the laser beam is executed by using the aforesaid unillustrated sampler 120.

FIG. 7 shows a graph for explaining a time taken for the reaction of the ACF by the laser irradiation according to the embodiment of the present invention. Here, the axis of ordinate represents a reaction rate, while the axis of abscissa represents a reaction time. FIG. 7 shows the reaction time in the experiment with solid-state laser that uses new birefringent crystal (YVO₄) that emits laser beam having wavelength of about 1064 nm.
reaction rate (%)=(h1−h2)/h*100 [Formula 1 ]
h1: DSC reaction heat (before laser irradiation)
h2: DSC reaction heat(after laser irradiation)

The DSC reaction heat indicates reaction heat measured in accordance with a so-called differential scanning calorimetry. The differential scanning calorimetry is an effective technique in which a difference in energy applied upon changing temperatures of a sample and authentic sample with a constant speed is measured for determining thermal analysis of the sample, for example, the heat of reaction or the like.

When the reaction rate is calculated from the heat of reaction in accordance with the aforesaid formula, the ACF can almost completely be cured at about 70 to 80 msec as shown in FIG. 7. If laser beam is too much irradiated, an abrasion or scorch is generated on the ACF, whereby the number of epoxy bonding increases to thereby increase the heat of reaction. Therefore, the reaction rate in accordance with the aforesaid formula is apparently negative after the ACF is completely cured. The solid line in FIG. 7 is an estimated curve estimated based upon the calculation result.

In the conventional method, it takes about 10 to 20 seconds to almost completely cure the ACF by the thermal conduction or the like. On the other hand, the method of the present invention can cure the ACF within below one-tenth of the time taken in the conventional method, with the result that the mounting using the ACF can be performed with extremely high efficiency. Since the time taken for curing the ACF is short, the thermal conduction to the array substrate (glass substrate) and TCP, that are the other components, can be restrained. Accordingly, a warping caused by the difference in temperature gradient can also be restrained. As a result, a complicated process such as a cooling process, which is at stake in the conventional method, is not required, so that an efficient mounting can be performed with simple configuration.

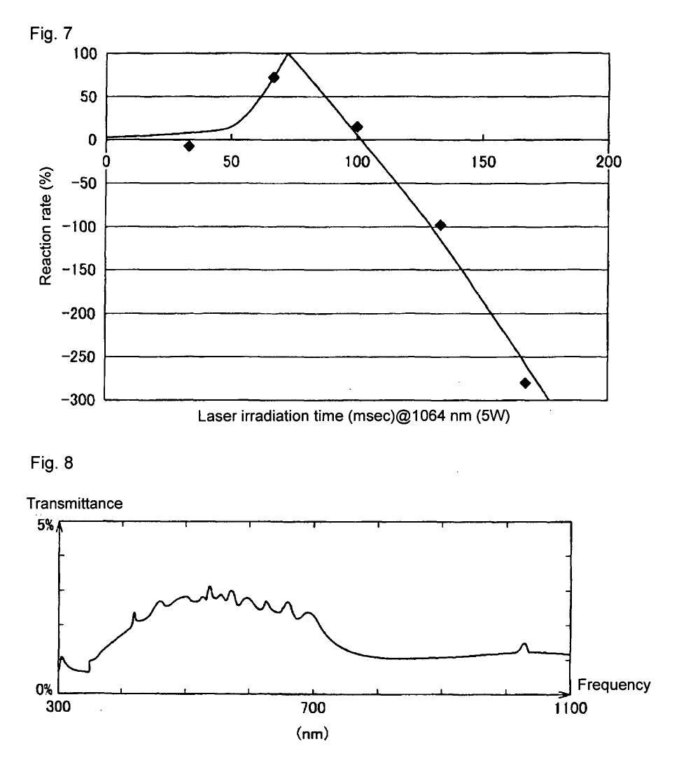

FIG. 8 shows a view for explaining a light transmittance of the ACF.

As shown in FIG. 8, it is understood that the ACF has extremely low laser transmittance for the laser irradiation. In other words, the ACF has greatly high laser absorptivity for the laser irradiation. For example, it is found by the measurement result of the experiment that the laser beam having wavelength of about 700 nm has lower transmittance and higher absorptivity of energy compared to laser beam having other wavelength. Accordingly, this embodiment is explained by taking as one example the case of using laser beam having wavelength of about 1064 nm.

In FIG. 7, the transmittance is naturally changed by the same manner as the reaction rate is changed due to the cure of the ACF.

In this embodiment, the curing state of the ACF is measured on real time by measuring the transmittance of the ACF on real time. Specifically, the transmittance of the ACF at an early stage upon the laser irradiation to the ACF is defined as a threshold value. When the transmittance is changed from the threshold value, it can be determined that the ACF is cured. This is achieved by the configuration described below. Specifically, the intensity of the laser incident on the measuring section 45 explained in FIG. 4 is measured. Then, the transmittance is calculated from the result of the measurement of the intensity of the laser incident on the measuring section 45 at the control section 70. This transmittance is compared to the threshold value, resulting in that the reaction rate of the ACF can be determined.

With this configuration, it is unnecessary to determine the reaction rate of the ACF based upon the DSC reaction heat as explained above. Specifically, in the above-mentioned differential scanning calorimetry, the other attached components should be removed for measuring only a sample, which is a destructive test. On the other hand, the method explained in this embodiment is a non-destructive test that can determine the curing state of the ACF based upon the transmittance of the ACF. Further, the method in this embodiment can measure the curing state of the ACF on real time, so that the prediction of reliability for each product is well possible. Further, cost for the test can be reduced.

The next bonding can be performed after the curing state of the ACF is determined by the aforesaid method. Therefore, the laser irradiation according to the curing state can be carried out, so that uniform and stable bonding can be expected. Moreover, a control with a learning function can also be executed by performing a process algorithm relating to information of knowledge in combination with correlated information such as past data of reaction rate or poor field.

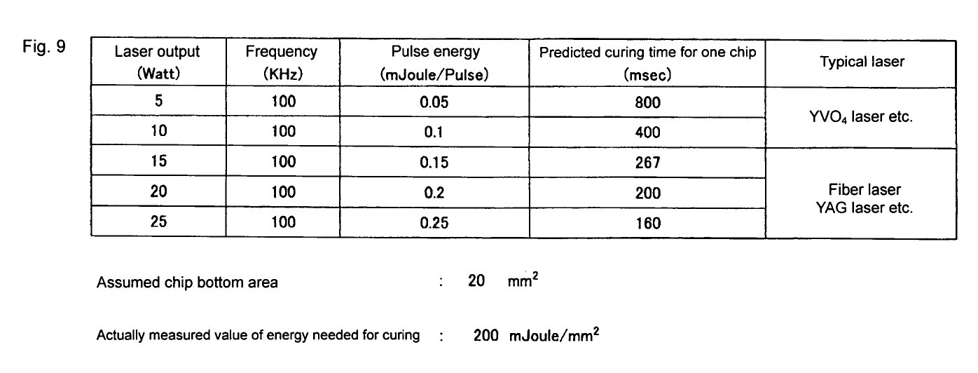

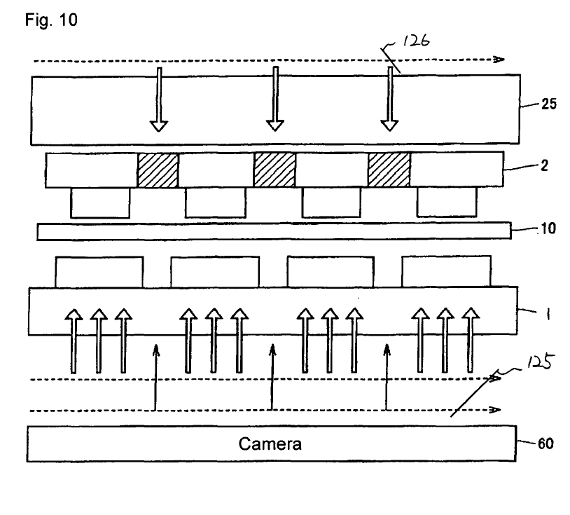

FIG. 9 shows a table for explaining a mounting time in case where the TCP is bonded by the bonding apparatus according to the embodiment 1 of the present invention.

This table includes laser output (Watt), frequency (kHz), pulse energy (mJoule/Pulse), predicted mounting time for one chip (msec), and example of typical laser beam. Note that the bottom area of the chip is assumed to be 20 mm². The actual measured value of the energy required for curing is 200 mJoule/mm². The examples of typical laser beam include here YVO₄ laser, fiber laser, YAG laser, or the like. The TCP can be mounted in a short period by irradiating laser power having high output. The result of the experiment showed that the mounting time per one chip was within one second. Therefore, it is understood that the use of the bonding apparatus according to the present invention enables greatly high-speed mounting.

As described above, the bonding apparatus according to the present invention, i.e., the ACF is irradiated by laser having predetermined wavelength, to cause the ACF to be reacted in a pinpoint manner, whereby the bonding time can be shortened. Therefore, high-speed and high-precise mounting can be carried out.

It should be noted that a semiconductor laser, YAG laser, solid-state laser using crystals such as YVO₄, or fiber laser may be used as the laser generator, wherein the laser is irradiated with a predetermined spot diameter and predetermined operation locus. The wavelength should be selected according to the variation in absorption band of chemical bond of OH group (hydroxyl group) of a glass. For example, it has been found that the transmittance at the wavelength of around 2.7 μm drops to almost zero. Further, the transmittance of microwave at about 4 μm to 10 μm is remarkably bad in general, so that it may actually give damage on the glass. In the present invention, it is possible to select appropriate wavelength considering absorption band or the like based upon a material.

The method of the embodiment of the present invention is not the one for curing the ACF by heat of thermal conduction with the use of a heater tool, but the one for welding the ACF by efficient and needed laser irradiation only when need arises for curing the ACF. Therefore, sufficient effects can be expected in view of effective power consumption.

In the use of the laser irradiation, the mounting energy can be greatly locally given to the ACF. Therefore, a minute mounting is made possible with high energy concentration efficiency to the ACF and high positional precision, by using monochromatic light.

In the conventional method, it is necessary to design components with a contraction correction provided beforehand, since the TCP, driver IC, array substrate (glass substrate) or the like is expanded by heat absorption upon the mounting. On the other hand, the method according to the embodiment of the present invention is a process of thermal reaction in extremely short period. Therefore, the contraction correction is unnecessary, to be idealistic, whereby greatly high-precise alignment can be realized.

Although the aforesaid embodiment relates mainly to a bonding apparatus executing the bonding of the array substrate (glass substrate) and TCP, the present invention is not limited thereto. The present invention is similarly applicable to other mounting techniques, such as COG mounting technique or a technique for fabricating components such as TAB/COF, or the like. Instead of the ACF, an adhesive made of heat-reactive resin containing no conductive particles can be used. In this case, the adhesive is cured as sandwiched between the array substrate and TCP by the application of pressure. Therefore, the bonding can be carried out with the opposing electrodes made conductive due to the contact therebetween.

### Embodiment 2

With the development in microfabrication technique, a wiring pitch is far reduced in recent years. Accordingly, a high-precise bonding has been demanded. However, the variation to some degree in a manufacturing stage should be considered, and a wiring pitch or the like should generally be designed considering the variation in a manufacturing stage. Specifically, the wiring pitch should be designed so as to be provided with a certain margin.

The embodiment 2 of the present invention describes an alignment correction method capable of performing high-precise bonding even if a wiring pitch is reduced.

FIG. 10 shows a view for explaining the alignment correction according to the embodiment 2 of the present invention.

Explained here is the case wherein the lower electrodes at the TCP and the upper electrodes at the array substrate (glass substrate) are bonded. Suppose that each upper electrode and each lower electrode have a convex shape. In general, the alignment in the vicinity of the bonding section is made by a CCD camera (simply referred to as “camera”). In this embodiment, the positional adjustment is executed by a camera 60 from below. Describing more precisely, the electrodes on the array substrate and the corresponding electrodes on the TCP are positioned and made close to each other, and then, photographed by the CCD camera with the ACF sandwiched between them before pressure is applied. It is determined which electrode of the plural arranged electrodes is deviated (deviation in pitch) from the captured image. The position of the deviated electrode is corrected such that, if the space between the electrodes on the array substrate is great, laser beam for the alignment is irradiated to the corresponding section on the TCP to be absorbed, thereby expanding the same corresponding section, and if the space is small on the contrary, the laser beam for the alignment is irradiated to the corresponding section on the array substrate to be absorbed, thereby expanding the same corresponding section. Thereafter, pressure is applied with the ACF sandwiched, and then, laser beam that is to be absorbed by the ACF is irradiated to bond the electrodes.

Specifically, upon bonding the upper electrodes and the lower electrodes, laser beam is irradiated to the ACF from below to weld the ACF and further, laser beam is also irradiated from above, as explained in the embodiment 1 described above. Describing more precisely, laser beam is irradiated from the laser section 40 explained in FIG. 4. Then, laser is irradiated to the space between the electrodes. With this irradiation, an extension is generated in the vicinity of the area between electrodes. The extension on the chip or on the film due to the laser irradiation is controlled, whereby the upper electrodes and the lower electrodes can precisely be bonded. The laser beam from the laser section 40 is desirably set to have a wavelength of passing through a glass and being easy to be absorbed by a chip package or film. The laser for the alignment may be irradiated not only to the space between electrodes but also the whole section (including electrodes) where positional deviation occurs due to the small space between electrodes.

Accordingly, by executing the alignment correction according to the present invention, wirings having narrow pitches can be bonded, so that the mounting with higher density can be made possible, although wiring should be designed to have a pitch provided with a margin in the conventional method. It is needless to say that, instead of TCP, an integrated circuit such as silicon chip or the like may be used. Further, it is possible to reverse the positional relationship of the array substrate (glass substrate) and TCP by selecting the wavelength with which the laser beam passes through.

While the present invention has been particularly described, in conjunction with a specific preferred embodiment, it is evident that many alternatives, modifications and variations will be apparent to those skilled in the art in light of the foregoing description. It is therefore contemplated that the appended claims will embrace any such alternatives, modifications and variations as falling within the true scope and spirit of the present invention.

What is claimed is:

1. A bonding method for physically and electrically bonding an extraction electrode composed of plural electrodes arranged on a glass substrate of a flat panel display and a connection electrode composed of plural electrodes arranged on a member, that has a thermal expansion coefficient and/or thermal contraction coefficient which are different from those of the substrate, so as to correspond to the extraction electrode, comprising:
a step A in which the extraction electrode on the glass substrate and the connection electrode on the member are made opposite to each other to position the respective electrodes, and an anisotropic conductive material having conductive particles dispersed in an adhesive made of heat-reactive resin is sandwiched between the glass substrate and the member by the application of pressure;
a step B in which laser beam is irradiated from a laser source, the laser beam passing through the substrate and/or the member to be absorbed by the anisotropic conductive material for heating the adhesive; and
a step C for releasing the pressure after the cure of the adhesive which occurs during the laser irradiation or after the laser irradiation.

2. A bonding method according to claim 1, wherein the pressure in the step A is applied by clamping the glass substrate, the anisotropic conductive material and the member between a pressure head and a support base, wherein the laser beam in the step B passes through the pressure head or the support base to be absorbed by the anisotropic conductive material.

3. A bonding method according to claim 2, wherein the extraction electrode and the connection electrode are photographed through the pressure head and/or the support base with the state before the application of pressure in which the extraction electrode and the connection electrode are positioned, and light absorbed by the glass substrate and/or light absorbed by the member are irradiated in accordance with the positional deviation amount of the photographed extraction electrode and the connection electrode, thereby correcting the positional deviation of the extraction electrode and the connection electrode in the step.

4. A bonding method according to claim 3, wherein the light absorbed by the glass substrate and/or the light absorbed by the member are irradiated between plural arranged electrodes.

5. A bonding method for physically and electrically bonding an extraction electrode composed of plural electrodes arranged on a glass substrate of a flat panel display and a connection electrode composed of plural electrodes arranged on a member, that has a thermal expansion coefficient and/or thermal contraction coefficient which are different from those of the substrate, so as to correspond to the extraction electrode, comprising:
a step D in which the extraction electrode on the glass substrate and the connection electrode on the member are made opposite to each other to position the respective electrodes, and an adhesive made of heat-reactive resin is sandwiched between the glass substrate and the member by the application of pressure;
a step E in which laser beam is irradiated from a laser source, the laser beam passing through the substrate and/or the member to be absorbed by the adhesive for heating the same; and
a step C for releasing the pressure after the cure of the adhesive which occurs during the laser irradiation or after the laser irradiation.

6. A bonding apparatus for physically and electrically bonding, as a bonded member, an extraction electrode composed of plural electrodes arranged on a glass substrate, and a connection electrode composed of plural electrodes arranged on a member, that has a thermal expansion coefficient and/or thermal contraction coefficient which are different from those of the substrate, so as to correspond to the extraction electrode, with an adhesive made of heat-reactive resin or an anisotropic conductive material having conductive particles dispersed in the adhesive inserted therebetween, comprising:
a first laser beam source for irradiating first laser beam having a predetermined wavelength to the adhesive made of the heat-reactive resin or the anisotropic conductive material for bonding the extraction electrode and the connection electrode by the heat generated from the adhesive; and
a support base that has a transmission area for transmitting the first laser generated from the first laser beam source and supports the bonded member;
wherein the first laser beam irradiated from the first laser beam source has high transmittance through the glass substrate and the member, and is set to have a wavelength with high absorptivity to the adhesive.

7. A bonding apparatus according to claim 6, further comprising a detecting unit for detecting the first laser beam transmitting the bonded member.

8. A bonding apparatus according to claim 7, further comprising a pressure unit for applying pressure to the bonded member with the support base, wherein
the pressure unit is made of a material having high transmittance of the first laser beam, and
the detecting unit detects the first laser beam transmitting through the pressure unit.

9. A bonding apparatus according to claim 8, wherein the pressure unit has an adsorption hole for applying pressure to the bonded member as vacuum-adsorbing the bonded member.

10. A bonding apparatus according to claim 7, wherein the reaction rate of the adhesive is measured based upon the light-receiving intensity of the laser beam detected by the detecting unit.

11. A bonding apparatus according to claim 10, further comprising a control unit that measures the reaction rate of the adhesive and controls the irradiation from the first laser beam source based upon the result of the measurement.

12. A bonding apparatus according to claim 6, further comprising a second laser beam source for irradiating second laser beam that is easy to be absorbed by the glass substrate or the member, wherein
the second laser beam is irradiated so as to adjust the bonding position of the corresponding other electrode to one of the extraction electrode or the connection electrode.

13. A bonding apparatus according to claim 12, wherein the second laser beam is irradiated between adjacent electrodes of the plural arranged electrodes to adjust the bonding position of the extraction electrode and the connection electrode.

14. A bonding apparatus according to claim 12, further comprising a pressure unit for applying pressure to the bonded member with the support base, wherein
the pressure unit is made of a material having high transmittance of the first laser beam and the second laser beam.

15. A bonding apparatus according to claim 6, wherein the first laser beam is at least one of semiconductor laser, solid-state laser or fiber laser.
